(19) United States
(12) Patent Application Publication
(10) Pub. No.: US 2026/0317072 A1
(43) Pub. Date: Oct. 15, 2026

(54) COMPUTER-IMPLEMENTED METHOD FOR DETERMINING CONVEYABILITY OF PIECE GOODS AND HANDLING DEVICE FOR DETERMINING THAT CONVEYABILITY

(71) Applicant: Körber Supply Chain Logistics GmbH, Konstanz (DE)

(72) Inventors: Marco Fischer, Konstanz (DE); Martin Schall, Konstanz (DE)

(21) Appl. No.: 19/577,876

(22) Filed: Mar. 25, 2026

(30) Foreign Application Priority Data
Apr. 7, 2025 (EP) 25168965.9

(51) Int. Cl. B65G 43/08; G06T 7/00

(52) U.S. Cl. CPC B65G 43/08; G06T 7/0004; B65G 2203/0208; B65G 2203/041; G06T 2207/20221

(57) ABSTRACT

A method for determining a conveyability of a piece good, includes acquisition or detection of image information of a piece good while it is being handled by a handling device, determination of piece good information based on the image information, and determination of a risk value based on the piece good information, whereby the risk value is indicative of the conveyability of the piece good, Also disclosed is and a related computer program and a handling device for determining the conveyability of the piece good.

### BACKGROUND

The present disclosure relates to a computer-implemented method for determining conveyability of piece goods of piece goods and a handling device for determining that conveyability.

On conveyor lines of a logistics network with individual parcel flow, it is standard practice for the piece goods conveyed on them, such as parcels or bags, to be detected at discrete registration points in order to obtain information about the piece goods. In operation, a logistics network of this sort has to handle a large number of piece goods in a very short time. In this method, light barriers are used, for example, to detect the piece goods. In practice, however, these light barriers may be impaired by dirt or other factors, which can result in discrepancies between the information detected and the information expected about the piece goods. The causes of these discrepancies or faults cannot be determined purely from the light barrier information. In addition, light barriers cannot provide continuous and centimetre-precise position information about an individual piece good on the conveyor line in real time. Furthermore, potentially obstructive or non-conveyable piece goods are sometimes not automatically detected in practice and therefore end up on the conveyor line, where a jam occurs or the piece goods end up on top of one another. For these reasons, a visual check for individual non-conveyable piece goods is currently carried out, and the piece goods are removed manually and transported individually. An automatic handling recommendation for each piece good to be transported is not possible precisely because the computing power of the programmable logic controllers of the conveyor units currently in use is not sufficient or their interfaces are not sufficiently flexible. This means that the exclusively discrete status information from the light barriers is not sufficient to provide an individual tracking history of each piece good and to ensure trouble-free operation of the conveyor line.

Due to the varied individual design of logistics networks, it is also difficult to establish general rules for conveyability and monitoring. Rather, manual sorting out of non-conveyable piece goods or articles that may cause faults is based on individual empirical criteria that are not derived from any standard specifications and have no statistical basis. In addition, the determination of these criteria in highly complex conveyor systems entails high operational costs, since time-consuming measurement of piece goods is required, for example, or employees have to develop a sense of appropriate proportions, which involves lengthy initial training. As a result, faults increasingly occur in automatic methoding and conveying of piece goods. The resulting conveying faults may not be detected, for example, leading to avoidable sorting errors. More re-identification methodes for individual piece goods and, in some cases, manual corrections of tracking errors are therefore necessary.

The fact that newly commissioned logistics networks often have to be optimised step by step through experience during operation and that effective operation is dependent on the experience of experts is a significant disadvantage.

The purpose of the present disclosure is therefore to provide a method that reduces dependence on the experience of logistics network operators for efficient operation. It is also desirable to increase the stability of the conveying method and its efficiency.

### SUMMARY OF THE INVENTION

According to one aspect of the present disclosure, a computer-implemented method for determining conveyability of piece goods is provided. The method optionally comprises: acquisition or detection of image information of a piece good while it is being handled by a handling device. The method can also include: determination of piece good information on the basis of the image information. Furthermore, the method can include: determination of a risk value based on the piece good information, whereby the risk value is indicative of the conveyability of the piece good.

In contrast to the previous approach, a handling device can be monitored by a vision system according to the subject matter of the present disclosure. The image information obtained in this way can then be analysed using algorithms (optionally AI-based). This means that piece goods can be tracked and monitored over the entire monitored route. Anomalies in the transport of piece goods can thus be identified from the position data. Anomalies can include relative distances between piece goods that shift position. Furthermore, the formation of doubles (i.e. piece goods lying on top of each other) can be detected. An anomaly can also include piece goods getting stuck on the handling device, piece goods being overtaken by other piece goods, jam formation, piece goods becoming jammed, piece goods experiencing lateral acceleration in curves (e.g. if there is insufficient adhesion between the conveyor device and the piece good), piece goods not strictly following the conveyor system but displaying anomalous movements, piece goods falling from the conveyor line, piece goods disintegrating into partial components, piece goods not behaving predictably (relative to the swarm/average of other piece goods), and/or piece goods being positioned incorrectly relative to the handling device (e.g. incorrect positioning on a sorter). It is also possible to detect twisting of piece goods When such anomalies are detected, they can be evaluated by the risk value (i.e. how significant is such an anomaly). Furthermore, the risk value can also be determined using one or more images of an piece good. One or more images of an piece good can be detected and fed to a classifier. The classifier can then identify properties from at least one image. The risk value can then be determined on the basis of the properties. For example, piece goods that are more likely to cause problems during handling can be identified at an early stage. In summary, the risk value can be determined based on the piece goods themselves (e.g. image information of the piece good) and/or the behaviour of the piece goods during handling. Based on the risk value determined in this way, piece goods classified as problematic can then be ejected from an automated handling chain at the next opportunity.

All the information about the piece goods, including image information and tracking, can be entered (in compressed form if necessary) in a database. If a problem can be clearly traced back to a single piece good, this can be noted. If required, this can also be done for combinations of piece goods or relations (e.g. bag followed by bag). This information can be used to calculate a risk value for each new piece good to determine whether or not it will lead to disruptions in conveying. By defining an acceptable overall risk, an operating point can be selected which ultimately determines which piece goods are ejected or rejected as a precaution. This configuration of the operating point can be defined individually for each handling device and can, for example, differentiate between different fault types.

The method can be carried out by the control unit of a monitoring system. The control unit can be designed to carry out the method stages of the method. The control unit can be a computer-like unit with a large number of interfaces. Furthermore, the control unit can be designed to receive and method the required information and issue commands. The method can be carried out on or in connection with a logistics network and with one or more handling devices of the logistics network. The monitoring system can monitor one or more handling devices or be part of one or more handling devices. The method can be carried out in particular during the handling of piece goods by the logistics network or at least one of the handling devices. The handling device can, for example, be a conveyor unit, such as a conveyor belt, or a manipulator, such as a gripper. The handling device can be designed to move an piece good physically in space. The piece good can be an item of mail, for example boxes, letters, packing bags, transport rolls, polybags, smalls and the like. This means that the piece goods can have an irregular external shape. Furthermore, the centre of gravity of the piece goods can deviate from the geometric centre of gravity of the piece goods. When the piece goods are handled by the handling device, the specific intention is to move the piece goods from a starting position to a target position over a period of time. During handling, the piece goods can assume a variety of intermediate positions, intermediate orientations, intermediate states or the like. During acquisition or detection, the intermediate positions, intermediate orientations or intermediate states that actually occur can be methoded as information. In other words, a digitally methodable signal can be generated for an piece good that is being handled. This can provide digital information about the position and/or condition of the piece good. Acquisition or detection can be carried out optionally by optical detection devices. For example, one or more cameras can be provided. Detection can mean that the image information is detected during execution of the method. For example, a vision system (i.e. a camera-based detection system) can be provided to monitor a handling device. Acquisition, on the other hand, can denote a situation in which the method is not carried out at the same time as detection. For example, the image information can be obtained from a database. This means that conveyability can also be determined retrospectively. This allows a learning system to be trained with data from the past. In particular, the detection device has communication interfaces to exchange information with the control unit. Image information can thus be acquired or detected by the detection device. The image information can include optical features of an piece good. The image information can include a discrete image of the piece good. In this context, discrete can mean that the image information is acquired or detected at a single point in time or at a number of different points in time that are different from one another. A wide range of image information can be provided. The term image information can therefore also be understood as a plurality of image information. Based on the image information, the piece good information can be determined by the method. The control unit can be used to determine the piece good information. In other words, the image information can be methoded and interpreted as piece good information. The piece good information can include properties of an piece good. Furthermore, the piece good information can be an influencing variable, in particular for determining a risk value. Determination can be understood as derivation or rule-based transfer. In other words, this means in particular recurring regularity. The piece good information can be determined individually for an piece good. A wide range of piece good information can be provided. It is also conceivable that the piece goods has a variety of different items of piece good information. This can have the effect that an piece good can be characterised as precisely as possible. A first item of piece good information can differ from a second item of piece good information about an piece good. For example, the position of the piece good can be represented by the first item of piece good information, whereas the second item of piece good information indicates the orientation of the piece good. This makes it possible to provide highly customised information acquisition. The piece good information can be stored in a data memory. The risk value can be an interpretation of the piece good information. The risk value can be determined on the basis of the piece good information of a first piece good and at least one other piece good. In other words, a large number of influencing variables can be used to determine the risk value. This allows the conveyability of the piece good to be determined according to the situation of the piece good. This means that a conveying path for the piece good can be dependent on the assigned risk value. In addition, relationships between a large number of different types of piece good can be covered. The conveyability can be a measure of a probability of whether the piece good can lead to a fault and/or impairment of the handling device during handling. In other words, conveyability can also be a measure of the transportability of the piece good. The risk value of the piece good can depend on piece good information that is linked to another piece good. Furthermore, the risk value can also be a decision criterion for determining whether the piece good is ejected from the handling device when a defined limit value is reached or exceeded. This means that piece goods that are highly likely to lead to a fault during the handling method can be ejected. The image information can, for example, be obtained from a large number of images (e.g. an image data stream) or from individual images. The image information can, for example, be an interpretation of image data. The image information can, for example, be a simplified representation of the monitored area. This can reduce the amount of data. Capturing or acquiring image information can involve classification. In other words, the output data can be fed to a classifier, which then provides the image information as output. The image information can be acquired as long as the piece good is being handled by the handling device. For example, the handling device can be a conveyor belt that moves, i.e. handles, an piece good. Furthermore, the handling device can be a robot that grips and moves an piece good. The piece good information can be a property of the piece good. For example, the piece good property can be a dimension of the piece good. It is also conceivable that the properties of the piece good include a surface quality, a centre of gravity, a weight, a material, or similar of the piece good. The piece good information can be determined using a classifier. Thus, the image information can be determined with a first classifier and the piece good information with a second classifier, whereby the first classifier differs from the second classifier. For determination of the piece good information, the image information can be fed to a classifier (e.g. the second classifier). The classifier can then output piece good information (one item of information or more) based on the image information. The risk value can, for example, be indicative of how likely it is that problems will occur with the respective piece good during further handling (e.g. during subsequent handling). It is conceivable that the risk value is a percentage value that is indicative of the conveyability of the piece good (i.e. indicates the probability that the piece good will lead to a problem).

This means that a self-sufficient method can be provided for determining conveyability that does not require any interfaces with conveyor technology or light barriers. Furthermore, the occurrence of handling problems can be reduced by identifying objects that cannot be conveyed. Furthermore, manual induction of objects can be carried out more quickly if a set of rules is simple or can be checked completely by the control system. This means that individual assessments by employees can be replaced by automated systems, resulting in an objective assessment. In addition, piece goods that regularly cause problems can be identified. It is also possible to optimise a system (i.e. a handling device) and identify faults. This facilitates performance and fault rates for each component (including third-party components) with high statistical accuracy at different operating points (throughput, material spectrum). Furthermore, load balancing can be made possible by intervening in the handling device in order to reduce fault rates.

Optionally, the image information can comprise an image package, which consists in particular of individual images. An image package can be understood as an image data stream. An image data stream can also be understood in particular as a video. In other words, images can be acquired or detected sequentially in time. The image package can be used to provide an approximately continuous acquisition or capturing of the image information. In this formulation, the term approximate can be interpreted as the number of images per time unit for representation of a fluid movement. According to this feature, the images can be interpreted one after the other in a time sequence. Compared to the light barriers known and used in the current state of the art, this results in the effect that, for example, the resolution of position determination, as piece good information, can be significantly increased. This means that digital tracking of the piece good can be provided with a high degree of realism.

Optionally, acquisition or detection can include a priori stitching of individual images to obtain the image information. A priori stitching can refer to information or assumptions that are already known before the actual analysis or experiment. Stitching can be the method of combining multiple images into a larger panorama or a single image. This means that image data coming from several cameras or sensor units (i.e. a vision system) can be combined to form an overall image data stream. Furthermore, a priori stitching can take into account previous information about the images or the scene to improve the stitching method. This information can include: Camera positions or camera movements that are known in advance Geometric assumptions or motion models that define the transformations between the images in advance Colour corrections or exposure adjustments that are defined in advance to ensure consistency between the images. The use of such a priori information can optimise the stitching method and increase the accuracy of image merging, especially when dealing with complex scenes or large image sets. It helps to minimise errors that could be caused by blurred transitions or distortions between the individual images. In other words, a large number of images can be brought together into one overall image without having to interpret the image information. In other words, images can be acquired or detected in parallel. This can have the effect that image information from different detection devices can be consolidated into a comparatively large overall image. This allows the image format of the detected image information to be adapted in such a way that a larger section can be depicted than would be possible with the image format of just a single detection device. Furthermore, the entirety of a handling device or a conveyor unit can be displayed in an image file or in image information. This means that a real-time image of the handling device or conveyor unit can be provided. Furthermore, the a priori stitching step can have upstream rectification of the individual images of the respective detection devices. This is intended to compensate for perspective distortion caused by different viewing angles, so that a distortion-free and true-to-scale overall image can be provided.

Optionally, the image information can be indicative of at least two different points in time. More precisely, this can mean that image information is recorded at one point in time t₀, whereas additional image information can be recorded at a second point in time t₁. This means that a discrete movement method can be represented by a large amount of recorded image information. In other words, a change in the position and/or orientation of the piece good can be monitored. This means that the image information of the piece good is detected not just once, but several times during the handling method. This repeated detection enables dynamic analysis of the piece good over a certain period of time, which leads to a more precise determination of conveyability. The image information can, for example, be detected at the beginning and end of a specific handling step or at regular intervals during the entire handling method. This approach makes it possible to recognise changes in the condition or position of the piece good that could indicate potential problems during conveying. By analysing image information at multiple points in time, the system can detect, for example, whether an object has changed its shape, whether it is moving in an unexpected way or whether it is in a position that increases the risk of faults. The integrity of an piece good can also be monitored (i.e. whether individual parts of the piece good become loose or change). This can mean that tracking of the piece good can be provided with a lower data volume and less computing power.

Optionally, the image information can be obtained or detected continuously. This means that the image information can be detected or obtained as a video or video stream. In other words, the time interval between a first detected image and a second detected image can be less than 0.1% of a second. In other words, more than 5 images per second can be recorded. This can reduce data traffic while providing sufficiently accurate tracking. Optionally, more than 20 images per second can be recorded. This enables the smoothest possible movement of the piece good. It also ensures that the highest possible resolution can be achieved when determining the position of the piece good. Continuously acquired image information can be understood to mean that images are recorded at a constant time interval. Alternatively, a recording of less than 5 images per second cannot be regarded as continuous recording of images.

Optionally, the method can further comprise identification of an piece good based on the image information, whereby the determination of the risk value can also be carried out based on the identification. This identification enables a more precise and specific determination of the risk value by providing additional data that goes beyond mere image information. The piece good can be identified by using pattern recognition algorithms or by comparing them with a database of known piece goods. This additional information makes it possible not only to analyse the piece good in general terms, but also to identify it specifically and include its individual characteristics and history in the risk assessment. This is particularly useful in complex logistics environments where a variety of different types of piece good with different conveyability and potential risks are handled. The significance of such identification lies in the increased precision and reliability of the risk assessment, as specific risks associated with certain types of piece goods can be taken into account. This leads to more efficient and safer handling of piece goods, as problematic objects can be recognised at an early stage and appropriate measures can be taken. In addition, identification of piece goods can also include use of historical data to identify patterns and trends in conveyability, which in turn supports the optimisation of logistics methodes. The integration of identification into the method therefore provides an enhanced basis for decision-making and helps to reduce transport and sorting faults. This method is particularly useful in automated systems where the ability to identify piece goods quickly and accurately is critical to smooth operation.

Optionally, the piece good information can be obtained or detected continuously. This means that the image information of the piece good is collected in real time and without interruption during the entire handling method by the handling device. Continuous recording of piece good information offers several benefits. Firstly, it enables seamless monitoring and tracking of the piece good, which increases the accuracy and reliability of the conveyability determination. Continuous detection also allows dynamic changes in the condition or position of the piece good to be identified, which could possibly be overlooked with detection at discrete points. In other words, the piece good information can be detected or obtained not only at fixed points in time but at any time. The frequency with which the piece good information is determined can depend on the frequency with which image information is obtained or detected. This can have the effect of increasing the accuracy of position determination as a result of increasing the frequency with which image information is obtained or detected. Furthermore, piece good information can be a dynamic value. In other words, the piece good information can also be variable. This means that a piece of information can take on a new variable value as a result of an update, for example with new image information. In this way, a method can be provided that can be continuously developed or learnt.

Optionally, the piece good information can comprise the following: a time stamp and/or position data of the piece good and/or a size for the piece good and/or a weight for the piece good and/or an piece good class and/or a distance of the piece good from the next piece good and/or a change in the handling sequence for the piece good and/or a change in position data of the piece good. Furthermore, the piece good information can also comprise a plurality of items of piece good information, whereby an item of piece good information can be represented by a tabular value entered in a table with a plurality of items of piece good information. In other words, piece good information can also be represented by a multidimensional vector, where each dimension of the multidimensional vector can be indicative of one of the aforementioned items of piece good information. It is also conceivable that the piece good information comprises more than just one dimension of the multidimensional vector. For example, the position data can comprise at least three dimensions, in particular six dimensions, of the multidimensional vector. A vector can be an ordered list of values that can represent different properties of an object. In this case, the vector describes the properties of an piece good (e.g. its position or orientation in space). Position data can have three or more dimensions (e.g. six dimensions). When we refer to three dimensions, we typically mean the Cartesian coordinates. This can be used to describe the position of the piece good in three-dimensional space in a coordinate system with x, y, z. When reference is made to more dimensions, orientation data such as roll, pitch and yaw can also be taken into account. Roll, pitch and yaw can describe rotational angles around the three axes and thus define the rotation of an piece good. This means that not only the position but also the orientation of an piece good in space can be detected. In addition to position and orientation data, other dimensions could be included in the vector, e.g.: speed, weight, dimension, surface quality and/or other condition information of the piece good under consideration. This piece good information can include a time stamp that makes it possible to document the exact time at which the image information was detected, which can be crucial for tracking and analysing transport faults. The position data of the piece good can provide precise information about the location of the piece good on the conveyor line, which makes it possible to analyse movement patterns and identify potential faults. The size and weight of the piece good are key physical parameters that can help determine conveyability, as they can influence the handling and transport of the piece good. An piece good class enables the categorisation of piece goods based on predefined criteria, which facilitates the application of specific sets of rules to determine conveyability. The distance between the piece good and the next piece good is a critical factor in avoiding collisions and congestion on the conveyor line. A change in the handling sequence of the piece good can indicate irregularities in the transport method that require an adjustment to the conveying strategy. Finally, changes in the position data of the piece good provide valuable insights into the dynamics of piece good transport by revealing deviations from the expected conveying movement.

The piece good information can also be determined using a machine vision method. The machine vision method can be used to determine features, in particular the piece good information, from an image file, such as the image information. This allows the piece good information to be determined automatically. Machine vision refers to technologies and methods used to detection and method visual information in a similar way to human vision. In this context, a machine vision method is used to analyse the image information of an piece good and derive relevant piece good information from it. This can include, for example, the size, shape, colour, texture or other visual characteristics of the piece good. Furthermore, it is also possible for a machine vision method to be self-learning, so that automatic determination of the piece good information can be adapted, in particular improved. As a result, the determination of the risk value, which is indicative of the conveyability of the piece good, can be increased. Optionally, the piece good information can depend on position data. This means in particular that the piece good information can be determined on the basis of further piece good information. For example, the distance between the piece good and the next piece good can be determined by comparing the position data of one piece good with the position data of the other piece good. In this way, relative relationships between one piece good and another piece good can be determined. In particular, this can resolve the formation of doubles.

Optionally, the piece good information can also be determined on the basis of sensor information. This sensor information can come from various sources, such as weight sensors, motion sensors or other physical detectors integrated into the handling device or along the conveyor line. Furthermore, a barcode reader can be provided as a sensor, which can identify the piece good by scanning a barcode or QR code or other means of identification. Based on this identification, piece good information can then be obtained. In particular, the piece good information can be retrieved from a database on the basis of the identification. It is also conceivable that detected piece good information relating to a detected identification is stored in a database. This means that the piece good information can be retrieved from the database when the piece goods are handled in the future. The inclusion of sensor information offers an additional dimension for analysing the piece good that goes beyond pure image information. In other words, piece good information, such as the weight of the piece good, can be measured by a scale as a sensor unit and this sensor information can be assigned to the piece good via the control unit. For example, sensor information can be detected by a light barrier and fed to the control unit. This allows redundant determination of the pose (position and orientation) of the piece good or the size of the piece good to be synchronised as piece good information. This can also be used to calibrate the respective piece good information, which is determined on the basis of image information.

Optionally, the image information and/or the piece good information can be stored in and/or linked to a database, in particular continuously. In other words, the image information and/or the piece good information can be transferred to the database, in particular by the control unit, and stored there. Continuous storage means that information is updated in real or near-real time, creating a dynamic and up-to-date database. This database acts as a central repository that makes it possible to analyse historical data and identify patterns that could indicate potential transport problems. One effect of this method is improved traceability and analysis of piece goods, as all relevant information is stored centrally and is easily accessible. This not only facilitates monitoring and management of piece goods, but also supports decision-making by enabling informed decisions to be taken on the basis of comprehensive data analyses. Another effect is the possibility of using the stored data to improve the algorithms used to determine conveyability. By analysing the stored image and piece good information, the algorithms can be continuously optimised to enable more precise risk assessments. In addition, linking the information in the database makes it possible to integrate it with other systems or data sources, which increases the interoperability and flexibility of the entire system.

Optionally, the method can comprise a further step, whereby monitoring of a fault condition during handling is provided, whereby in the event of a fault occurring, this fault is assigned to the piece good information. The fault state can be the state of the handling device or the sensor unit in which there is a random deviation from the pre-planned and/or planned transport of one or more piece goods. In other words, faults can include, for example, a jam of piece goods or incorrect identification of the piece good. If the method, which can be carried out by the control unit, detects a fault, this fault can be linked to the piece good that triggered the fault. To be more precise, this piece good in particular is provided with piece good information that refers to the fault or potential triggering of the fault. This allows the conveyability of the respective piece good to be determined.

Optionally, the risk value can be determined individually for the piece good. In other words, each piece good can be assigned its own risk value. This means that the conveyability of each piece good can be determined by its risk value. This can have the effect that each piece good can be conveyed or ejected individually. In this context, monitoring of a fault condition refers to continuous observation and detection of anomalies or irregularities that can occur during the transport or handling of the piece good. These fault conditions can take various forms, such as an piece good getting stuck, jams forming, an piece good tipping over or twisting, or an piece good falling apart into sub-components. Assigning the fault to the piece good information means that specific data about the piece good, such as its identity, position and movement pattern, is linked to the recognised faults. This makes it possible to trace and analyse the causes of transport faults precisely. Integration of this additional step brings about several effects. On the one hand, it enables detailed and accurate diagnosis of problems that occur during transport, which leads to improved troubleshooting and optimisation of the conveyor line. On the other, it contributes to continuous improvement of the algorithms used to determine conveyability by providing a rich database for machine learning and statistical analyses. In addition, the allocation of faults to specific piece goods can help to identify recurring problems and develop targeted measures to prevent future faults. This ultimately leads to a reduction in transport and sorting disruptions, an increase in operational efficiency and a reduction in operating costs.

Optionally, the risk value can be determined by at least two items of piece good information. In other words, the risk value of the piece good can depend on two or more items of piece good information. However, a large number of influencing factors can be taken into account in making an accurate assessment of the conveyability of the piece good. Combinations of different items of piece good information can also lead to a critical risk value, whereby an individual item of piece good information taken on its own would not lead to the critical risk value. This allows the piece good to be conveyed in a way that is particularly suited to the situation.

Optionally, at least individual items of piece good information can be defined as dominant. In this context, the term dominant means that a single item of information can be sufficient to determine a critical risk value. In other words, the dominant item of information can be sufficient for a critical risk value, even if a combination of other risk values would not lead to the critical risk value. An piece good can have or be associated with one or more dominant items of piece good information. This means that, as part of the method, one or more specific items of information about the piece good that are derived from the image information are categorised as particularly relevant or having priority. These dominant items of piece good information can include various characteristics of the piece good, such as size, shape, weight, surface properties or other physical properties that are decisive for conveyability. The determination of dominant items of piece good information makes it possible to calculate the risk value more precisely by highlighting and prioritising the most important features of the piece good.

Optionally, the risk value can be variable during handling and/or can be continuously updated for the piece good. In other words, the risk value in particular is not a fixed value, but can be adjusted by updating the piece good information. For example, if an piece good is released from a fault state and transported again by a conveyor belt as intended, this could be recorded by the associated image information and lead to an update of the piece good information. Based on this change, the determination of the risk value can be altered so that it is no longer in a critical range but in a non-critical range. This allows a reactive system range to be created, which can react to changes during handling. It is also possible that the risk value of an piece good changes during handling in such a way that it then lies within the critical range. This can be the case if an piece good does not move along a pre-planned path. Or if the shape of the piece good changes during handling. This allows a particularly comprehensive assessment of the conveyability of the piece good to be provided. This means that the risk value is not static, but is dynamically adjusted as the piece good is being moved by the handling device. The risk value is an indicator of the conveyability of the piece good and is determined on the basis of the piece good information derived from image information.

Optionally, the risk value can be binary. Binary can be understood to mean that the risk value is either high or low, 0 or 1. This means that the risk value can only assume two possible states, typically “conveyable” or “not conveyable”. This binary classification simplifies the decision-making method considerably, as it provides a clear and unambiguous statement about the conveyability of the piece good. This feature can have the technical effect that the risk value is directly and easily machine-readable. More precisely, a light or warning tone can be emitted directly and without the need for an additional control unit. This is a simple and cost-effective way of indicating a range in which an piece good is in a non-conveyable state. This can speed up the method of restoring the conveyability of the piece good in question.

Optionally, the method can further comprise the step of comparing the risk value with the threshold value or working value. In this context, the risk value refers to a numerical or qualitative assessment calculated on the basis of specific piece good information derived from image information. This piece good information could include, for example, the size, shape, weight or behaviour of the piece good during transport. The threshold value or working value serves as a reference point for deciding whether the piece good is conveyable or not. Comparing the risk value with this threshold value enables an objective and consistent decision to be made as to whether the piece good can continue to be transported or should be ejected from the conveying method. In other words, a limit value can be determined at which a risk value could be assessed as non-critical and at which a risk value could be assessed as critical if this limit value is reached and/or exceeded. This enables simple and fast characterisation of a status as OK or NOK.

Optionally, the threshold value can be variable. In other words, the threshold value can be adjusted during operation of a handling system. There can be an initial threshold value that is used to determine when a risk value assumes a value at which the corresponding piece good cannot be handled by the handling system. It is possible to check iteratively whether the handling of an piece good works without problems if the threshold value is increased. It is also possible to check whether a handling result is improved (e.g. increased speed and/or increased throughput) if the threshold value is lowered. This makes it possible to check during operation of the handling device whether better operating results are achieved if the threshold value is adjusted. This allows the method to be adapted to a new range of piece goods, for example. Overall, this provides a method that can adapt to changing boundary conditions.

Optionally, the risk value can be determined by a self-learning algorithm. It is conceivable that a method for machine learning is included, which methodes a large number of input variables (items of piece good information) and adapts self-learning rules for methoding the input variables in order to be able to output the risk value. A self-learning algorithm, often referred to as machine learning, is a system that learns from data and improves its performance over time without being explicitly programmed. In this context, the self-learning algorithm enables dynamic adaptation and optimisation of the risk assessment by continuously learning from the collected data and identifying patterns or anomalies that could indicate potential non-conveyability. The risk value can depend on the state of the machine learning, whereby the same item of information can be entered in each case. It is conceivable, for example, that a risk value can be assigned by means of a linear regression based on the piece good information. This enables the simplest possible allocation. Deep learning algorithms can also be part of the self-learning algorithm. In other words, neural networks can represent a particularly simple method for determining a simple and customisable self-learning algorithm for determining a risk value based on piece good information.

Optionally, the method can also include an additional step, whereby an initial risk value can be assigned to an piece good value. The initial risk value can be the risk value that an piece good initially has. In other words, the initial risk value of the piece good can depend on initial piece good information. The initial piece good information can be the piece good information that is assigned to an piece good at first. The initial risk value can be assigned to the piece good as soon as the piece good is initially detected. This can have the effect that the piece good can be ejected as early as possible in the handling method if it is assessed as not suitable for conveying. The initial risk value can become the risk value as a result of changes in future piece good information. By continuously updating the initial risk value to the risk value or updating the risk value itself, a learning method can be provided. This means that a self-learning algorithm can be executed in the control unit. As a result, the variance in the determination of the risk value can be reduced and thus a measure of the conveyability of the piece good can be adjusted.

Optionally, the method can include an additional step whereby the piece good can be handled in accordance with the risk value. In other words, the risk value can be a threshold value that determines whether the piece good can be transported on the conveyor unit, in particular the specific conveyor unit, or whether the piece good should be transferred to an alternative conveyor unit. This means that once the risk value, which indicates the conveyability of the piece good, has been determined, the piece good is handled according to this value. The handling can include various actions, such as ejecting the piece good from the conveyor line, adjusting the conveyor speed or diverting the piece good to an alternative route. The risk value is calculated on the basis of the previously determined piece good information, which is derived from the image information of the piece good. This image information is detected while the piece good is being handled by a handling device. The specific communication mechanisms or means of interaction between the components include the detection of image information by camera systems, the methoding of this image information by algorithms, which can be AI-based, and the subsequent calculation of the risk value by a centralised system. These centralised systems can collate information from various sources and derive decisions from it.

Optionally, the handling device can have a control unit, whereby the image information and/or the piece good information and/or the risk value can be determined or ascertained by the control unit. The control unit can be a computer unit or a general data methoding unit. Furthermore, the control unit can be the control unit mentioned above. The control unit can also be designed to cause an piece good to be transported, ejected or transported on by the alternative conveyor unit depending on its risk value. The control unit can be designed to record the image information as an incoming variable. Furthermore, the control unit can be designed to generate piece good information based on the image information. In addition, the control unit can be designed to generate a risk value based on an item of piece good information. Furthermore, the control unit can be designed to output the risk value as an output variable. The control unit can therefore be a central element of the handling device. Furthermore, it is also conceivable that the control unit is part of a monitoring system, whereby the monitoring system can in turn be part of the handling device.

Optionally, the handling device can have a database, and the control unit can communicate with the database. The database can also be the database mentioned above. The database can be understood as or comprise a memory, in particular a data memory, such as a hard disk like an SSD or HDD or other storage medium. The database can be changed or manipulated by the control unit in such a way that the database stores the image information and/or risk value, whereby this information can be assigned to the piece good, in particular to an individual piece good. In addition, the control unit can be designed to load the piece good information from the database, modify it and transfer it back to the database. The same can also be done with the image information and/or the risk value by the control unit. This can achieve the technical effect that the method can react adaptively to changing real-life circumstances. Optionally, the image information and/or the piece good information and/or the risk value can be stored and/or linked in the database by the control unit.

Optionally, the above method can be applied individually to a variety of handling systems. This means that a separate risk value can be developed for each handling system. In other words, a piece good may not cause any problems with one handling system, while the same piece good is more likely to cause problems with another handling system. Different risk values (i.e. for a number of different handling devices) can also be determined locally at one point in a handling chain for an piece good. This makes it possible to determine when the piece good needs to be ejected or diverted in order to avoid a potential problem in handling the piece good. For example, different piece good information can be taken into account for the different risk values. For example, with a conveyor belt it is irrelevant what the external condition of an piece good is, whereas this is an essential characteristic for a suction gripper. In this respect, different threshold values can be entered depending on the handling device in question. This means that the above method can also be used, for example, in a mail centre with a large number of different handling devices.

It is conceivable that the database comprises a large number of other databases, whereby the separate databases are linked to each other. The identification code can be used as a key attribute between one database and another, which can indicate the piece good in question. This allows a complex and flexible data structure to be created. Furthermore, it allows extremely stable execution of the method by the control unit.

According to a further aspect of the present disclosure, a computer program can be provided comprising instructions which, when the program is executed by a computing device, cause the computing device to execute the method. In other words, the computer program can be executed on the control unit. This means that the computer program can fulfil all the properties and capabilities that are assigned to the control unit if the computer program is executed on the control unit.

According to a further aspect of the present disclosure, a handling device for determining the conveyability of an piece good is provided. The handling device can comprise at least one conveyor. Furthermore, the handling device can comprise an image detection device, in particular several cameras, with a detection area for capturing image information. The handling device can include a control unit. The control unit can be designed to determine piece good information on the basis of the image information. The control unit can also be designed to determine the risk value on the basis of the image information. The handling device can correspond to the handling device mentioned above. This means that what was stated above about the handling device also applies to this handling device. At least one conveyor unit can be a conveyor unit, which in turn can be either a conveyor belt or a gripper. In other words, more than one conveyor can be assigned to the handling device. For example, a conveyor belt can be designed to convey one or more piece goods, in particular individually, whereby a second conveyor belt is only designed to eject non-conveyable piece goods from the quantity of piece goods that are to be conveyed on the first conveyor belt. This provides an automatic and stable method for conveyable piece goods. The image detection device can optionally be a device that can perceive objects by means of optical detection. Optionally, these objects can be the piece goods. More specifically, the image detection device can be a camera. This makes it easy to detect images. It is also conceivable that a large number of cameras are part of the image detection device. Consequently, the image information can include different image formats. This can have the effect that an image format can be displayed that exceeds the image format of a single camera. In other words, the image detection area, which can be defined by a camera's angle of view, can be extended by a large number of cameras. The control unit can be the control unit mentioned and described above. The image information from the camera or several cameras can be fed to the control unit, whereby the control unit is designed to derive or determine the piece good information from this image information. As a consecutive next step, the control unit can be designed to determine the risk value based on the piece good information.

Optionally, the conveyor can be contained at least in sections, in particular completely, within the detection area of the image detection device. In other words, the detection area, which can be determined by the camera or by several cameras, can be designed in such a way that it has a format that is designed precisely to record and/or depict the entire extent of the conveyor. This can have the effect of a particularly fast and efficient determination of the piece good information, whereby the entirety of the conveyor and the piece good on it can be taken into account.

Optionally, at least one camera can communicate with the control unit. This allows data to be exchanged between one or more cameras and the control unit. In other words, the camera or cameras can exchange images or image data streams with or transmit them to the control unit via a common interface. This allows piece good information to be detected indirectly by the cameras by which the image information is provided.

Individual features and embodiments can be combined with other features and embodiments to form new embodiments. The embodiments and advantages of the embodiments and features also apply to the new embodiments and features and vice versa. In particular, all the advantages and features of the method for determining the conveyability of an piece good and of the computer program can be transferred analogously to the handling device for determining conveyability and vice versa.

### BRIEF DESCRIPTION OF THE DRAWINGS

Further embodiments and further features are given in the following description with reference to the figures. Individual features disclosed in the embodiments shown can also be used in the other embodiments, unless this has been expressly excluded. The figures include:

FIG. 1 is a schematic flow chart of a method for determining the conveyability of an piece good according to an embodiment of the present disclosure; and

FIG. 2 is a schematic representation of a handling device for handling an piece good according to an embodiment of the present disclosure.

### DETAILED DESCRIPTION OF THE PREFERRED EMBODIMENTS

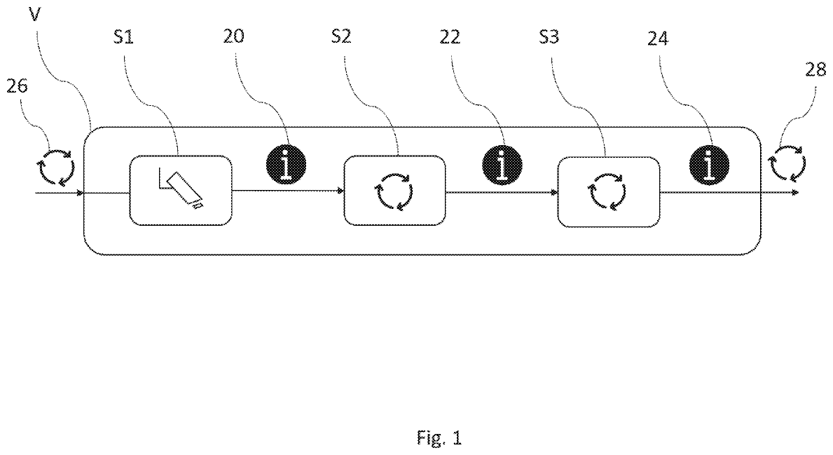

FIG. 1 shows a schematic flow chart showing the method steps for determining the conveyability of an piece good 2 according to one embodiment of the present disclosure. The method P, as shown on the flow chart, can be carried out on a handling device 1 or in connection with a handling device 1. This handling device 1 can in turn be part of a logistics network or form a logistics network. In addition, the illustrated method P can be performed on or by a control unit 14, whereby the control unit 14 can be part of the handling device or the logistics network. The handling device 1, which can be or comprise a conveyor unit, can be used to manipulate the pose (position and orientation) of an piece good 2, for example. In other words, the handling device 1 can change the state of the piece good 2. The step of handling an piece good 26 can be part of the method P or can be performed before and/or during and/or after the method P. The aim of this method P is automatic determination of the conveyability of the piece good 2. In this way, both conveyable and non-conveyable piece goods 2 can be detected and transported further by means of alternative and/or appropriate handling. In a first step S1, image information 20 of the piece good 2 is obtained or detected while it is being handled by the handling device 1. This step S1 can be performed in connection with an image detection device 6, wherein the image detection device 6 comprises or communicates with at least one camera 8. The images detected by the image detection device 6 or the detected image data stream can then be converted, transferred or analysed by the control unit 14 to form the image information 20. In the further, in particular consecutive next, step S2, an item of piece good information 22 is determined based on the image information 20. In other words, the control unit 14 can interpret the image information 20 for the piece good information 22. A machine vision method can be used for this purpose, for example. The piece good information 22 can be indicative of the condition of the piece good 2. The piece good 2 can have a number of items of piece good information 22 or these can be assigned to the piece good 2. In other words, the piece good information 22 can be a digital image of the piece good 2 being handled by the handling device 1. The piece good information 22 or the multiple items of piece good information 22 of an piece good 2 can also be understood as a digital twin or be a component thereof. The control unit 14 can also be configured to perform the third step S3, whereby a risk value 24 is determined on the basis of the piece good information 22, whereby the risk value 24 is indicative of the conveyability of the piece good 2. In other words, the risk value 24 can depend on the piece good information 22, which is assigned to an piece good 2. Furthermore, the risk value 24 can be a type of decision-making variable, so that the handling unit 1 can be prompted or controlled to handle the piece good 2 depending on the risk value 24. The piece good 2 can, for example, be ejected from the conveyor unit when a threshold or limit value is exceeded by the risk value 24 or transported further on an alternative and/or appropriate conveyor unit. The conveyability 28 of an piece good can be the result of method P or can be utilised as a result of method P for possible further downstream steps. The image information 20 and the piece good information 22 can be updated in particular. This can also result in the risk value 24 changing during the handling of the piece good 2 and/or a learning system being provided.

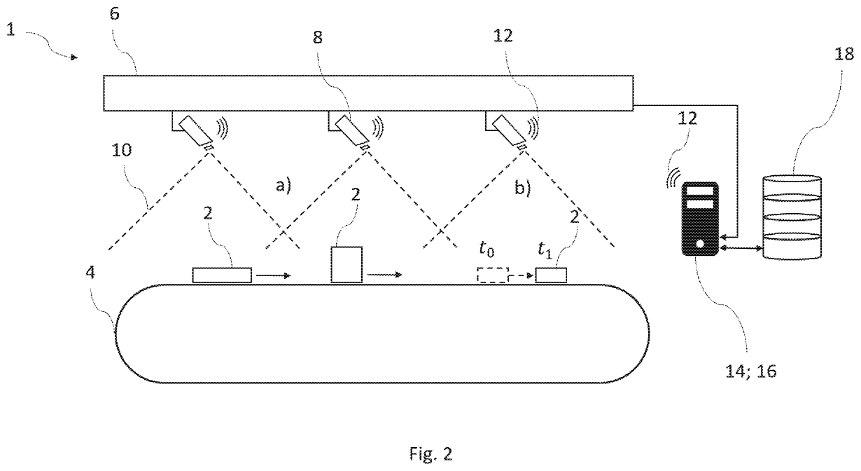

FIG. 2 shows a schematic representation of a handling device 1 for handling an piece good 2 according to an embodiment of the present disclosure. The handling device 1, which can be part of a logistics network or can at least partially form such a network, comprises a conveyor unit or conveyor 4. An piece good 2 or several piece goods 2 can be moved over a period of time by the conveyor 4, in particular their pose can be changed. An image detection device 6 is arranged in an operating state above the conveyor 4, conceivably also on the ceiling of a building. This means that the conveyor 4 can be arranged in a visible area of the image detection device 6. According to the embodiment shown in FIG. 2, the image detection device 6 has several cameras 8. Each of these cameras 8 has a detection area 10. In particular, the image area of the camera 8 that can be detected can be seen. As shown in FIG. 2, the detection areas 10 of neighbouring cameras 8 can overlap. This makes it possible to merge individual images from different cameras 10 into one image file, i.e. a complete image. For example, a control unit 14 can be designed to compensate for distortions caused by different viewing angles of the cameras by means of a rectification step so that a true-to-scale overall image can be provided. This enables exact determination of an item of piece good information 22 based on image information 20. In particular, the control unit 14 can be triggered by a computer program 16 to perform this and other operations. The control unit 14 can be designed to communicate with the image detection device 14, in particular the camera(s). In the embodiment shown in FIG. 2, this communication is represented by a wireless information transmission interface 12. It is also conceivable that the communication can be wired. A database 18 is arranged on the control unit 14. The database 18 can also be part of the control unit 14. It is also conceivable that the database 18 can be cloud-based. This enables flexible access to the database 18. Because the control unit 14 is designed in particular to communicate with the database 18, information stored in the database can be obtained from the control unit 14 and stored in the database 18 by the control unit. It is also possible for information already contained in the database 18, such as image information 20, piece good information 22 or a risk value 24, to be replaced or updated, in particular by new information. Furthermore, FIG. 2 shows a representation of two different individual piece goods 2 marked a). In this way, in particular piece goods 2 of different geometrical shape can be transported through the conveyor 4, with the different piece goods 2 being located within the detection area 10. The label b) shows a movement method of an piece good 2 at a time t₀ and a time t₁, whereby the position of the piece good differs at the two points in time. The piece good 2 is located within the detection area 10 at both points in time. The image information 20 of the piece good 2 detected by the camera 8 at the time to can be transmitted to the control unit 14. The control unit 14 is designed in particular to store this image information 20 in the database 18 and also to determine the corresponding piece good information 22 based on the image information 20 and also to store this in the database 18. Furthermore, the control unit 14 can be designed to determine the risk value 24 based on the determined piece good information 22 and also to store this in the database 18. At the time t₁, these steps can be repeated so that the information stored in the database 18 and associated with the piece good 2 can be updated or modified.

### LIST OF REFERENCE NUMBERS

1 Handling device
2 Piece good
4 Conveyor
6 Image detection device
8 Camera
10 Detection area
12 Information transmission interface
14 Control unit
16 Computer program
18 Database
20 Image information
22 Piece good information
24 Risk value
26 Handling
28 Conveyability
S1 Acquisition or detection of image information
S2 Determination of piece good information
S3 Determination of a risk value
P Computer-implemented methodes

The invention claimed is:

1. A computer-implemented method for determining a conveyability of an piece good, comprising:
acquisition or detection of image information of a piece good while the piece good is being handled by a handling device;
determination of piece good information on a basis of the image information; and
determination of a risk value on the basis of the piece good information, wherein the risk value is indicative of the conveyability of the piece good.

2. The method according to claim 1, whereby acquisition or detection of image information comprises a priori stitching of individual images.

3. The method according to claim 2, whereby the image information is indicative for at least two different points in time.

4. The method according to claim 3, whereby the image information is continuously acquired or detected.

5. The method according to claim 4, further comprising:
identification of the piece good on the basis of the image information, whereby the determination of the risk value is additionally carried out on the basis of the identification.

6. The method according to claim 5, whereby the piece good information comprises at least one of:
a time stamp;
position data of the piece good;
a size for the piece good;
a weight for the piece good;
a piece good class;
a distance between the piece good and the next piece good;
a change in the handling sequence for the piece good; and
a change in the position data of the piece good.

7. The method according to claim 6, whereby the piece good information is determined by a machine vision method.

8. The method according to claim 1, whereby the piece good information is additionally determined on the basis of sensor information.

9. The method according to claim 1, whereby the risk value is determined individually for the piece good.

10. The method according to claim 1, whereby the risk value is variable during handling and/or is continuously updated for the piece good.

11. The method according to claim 1, whereby the method further comprises:
comparison of the risk value with a threshold value or working value.

12. The method according to claim 1, whereby the risk value is determined by a self-learning algorithm.

13. The method according to claim 1, further comprising:
assignment of an initial risk value to the piece good.

14. The method according to claim 1, further comprising:
handling of the piece good based on the risk value.

15. The method according to claim 1, whereby the image information is indicative for at least two different points in time.

16. The method according to claim 1, whereby the image information is continuously acquired or detected.

17. The method according to claim 1, further comprising:
identification of the piece good on the basis of the image information, whereby the determination of the risk value is additionally carried out on the basis of the identification.

18. The method according to claim 1, whereby the piece good information comprises at least one of:
a time stamp;
position data of the piece good;
a size for the piece good;
a weight for the piece good;
a piece good class;
a distance between the piece good and the next piece good;
a change in the handling sequence for the piece good; and
a change in the position data of the piece good.

19. The method according to claim 1, whereby the piece good information is determined by a machine vision method.

20. A handling device for determining the conveyability of a piece good, comprising:
at least one handling device configured to handle a piece good;
an image detection device including a plurality of cameras and with a detection space for capturing image information; and
a control unit;
whereby the control unit is configured to determine piece good information on the basis of the image information; and
whereby the control unit is further configured to determine the risk value on the basis of the image information.
